(19) United States
(12) Patent Application Publication
(10) Pub. No.: US 2011/0182354 A1
(43) Pub. Date: Jul. 28, 2011

(54) Low Complexity, High Frame Rate Video Encoder

(76) Inventors: Wonkap Jang, Edgewater, NJ (US); Michael Horowitz, Austin, TX (US)

(21) Appl. No.: 13/007,193

(22) Filed: Jan. 14, 2011

Related U.S. Application Data
(60) Provisional application No. 61/298,423, filed on Jan. 26, 2010.

(51) Int. Cl. H04N 7/26

(52) U.S. Cl. 375/240.02; 375/E07.076

(57) ABSTRACT

Disclosed herein are techniques and computer readable media containing instructions arranged to utilize existing video compression techniques to enhance a visually appealing high frame rate, without incurring the bitrate and computational complexity common to high frame rate coding using conventional techniques. SVC skip slices—slices in which the slice_skip_flag in the slice header is set to a value of 1—require very few bits in the bitstream, thereby keeping the bitrate overhead very low. Also, when using an appropriate implementation, the computational requirements for coding an enhancement layer picture consisting entirely of skipped slices are almost negligible. In addition, skipped slices in an enhancement layer inherit motion information from the base layer(s), thereby minimizing, if not eliminating, the possibly bad correlation between nonlinear motion and linear interpolation. Further, the issue of radical brightness changes of a picture (or significant part thereof) does not exist, as the base layer is coded at full frame rate and can contain information related to the brightness change that can also be inherited by the enhancement layer.

### CROSS-REFERENCE TO RELATED APPLICATIONS

This application claims the benefit of priority to United States Provisional Application Ser. No. 61/298,423, filed Jan. 26, 2010 for “Low Complexity, High Frame Rate Video Encoder,” which is hereby incorporated by reference herein in its entirety.

### FIELD OF THE INVENTION

The invention relates to video compression. More specifically, the invention relates to the novel use of existing video compression techniques to enhance a visually appealing high frame rate, without incurring the bitrate and computational complexity common to high frame rate coding using conventional techniques.

Subject matter related to the present application can be found in U.S. Pat. No. 7,593,032, filed Jan. 17, 2008 for “System And Method for a Conference Server Architecture for Low Delay and Distributed Conferencing Applications,” and co-pending U.S. patent application Ser. No. 12/539,501, filed Aug. 11, 2009, for “System And Method For A Conference Server Architecture For Low Delay And Distributed Conferencing Applications,” which are incorporated by reference herein in their entireties.

Many modern video compression technologies utilize inter-picture prediction with motion compensation and transform coding of the residual signal as one of their key components to achieve high compression. Compressing a given picture of a video sequence typically involves a motion vector search and many two-dimensional transform operations. Implementing a picture coder according to these technologies requires a technology with a certain computational complexity, which can be realized, for example, using a software implementation of a sufficiently powerful general purpose processor, dedicated hardware circuitry, a Digital Signal Processor (DSP), or any combination thereof. The compressed video signal can include components such as motion vectors, (quantized) transform coefficients, and header data. To represent these components, a certain amount of bits are required that, when transmission of the compressed signal is desired, results in a certain bitrate requirement.

Increasing the frame rate increases the number of pictures to be coded in a given interval, and, thereby, increases both the computational complexity of the encoder and the bitrate requirement.

The human visual apparatus is known to be able to clearly distinguish between individual pictures in a motion picture sequence at frequencies below approximately 20 Hz. At higher frame rates, such as 24 Hz (used in traditional, film-based projectors cinema), 25 Hz used in European (PAL/SECAM) or 30 Hz used in US (NTSC), picture sequences tend to “blur” into a close-to-fluid motion sequence. However, depending on the signal characteristics, it has been shown that many human observers feel more “comfortable” with higher frame rates, such as 60 Hz or higher. Accordingly, there is a trend in both consumer and professional video rendering electronics to utilize higher frame rates above 50 Hz.

High frame rates such as 60 Hz are desirable from a human visual comfort viewpoint, but not desirable from an encoding complexity viewpoint. However, keeping the whole video transmission chain in mind, it is of advantage if the decoder is forced to decode (and display) at a higher frame rate, even if the encoder may have only the computational capacity or connectivity (e.g., maximum bitrate) suitable for a lower frame rate, such as 30 frames per second (fps). A solution is needed that allows a decoder to run at a high bitrate with a minimum of bandwidth overhead and no significant computational overhead, and further allows all decoders capable of handling the operation to present an identical result.

Techniques for frame rate enhancements local at the decoder have been disclosed for many years, often referred to as “temporal interpolation.” Many higher-end TV sets available in the North American consumer electronics markets that offer 60 Hz, 120 Hz, 240 Hz, or even higher frame rates, appear to utilize one of these techniques. However, as each TV manufacturer is free to utilize its own technology, the displayed video signal, after temporal interpolation, can look subtly different between the TVs of different manufacturers. This may be acceptable, or even desirable as a product differentiator, in a consumer electronics environment. However, in professional video conferencing it is a disadvantage. For example, in Telemedicine or in law enforcement related video transmission use cases, video surveillance and similar, the introduction of endpoint-specific and non-reproducible artifacts must be avoided for liability reasons.

Decoder-side temporal interpolation, at least in some forms, also has an issue with non-linear changes of the input signal. The human visual system is known to perceive relatively fast changes in lighting conditions. Many humans can observe a difference in visual perception between an image that switches from black to white in 33 ms, and two images that switch from black through gray to white in 16 ms, respectively.

Coding the higher frame rate with a non-optimized encoder may not be possible due to higher computational or higher bandwidth requirements, or for cost efficiency reasons.

Out-of-band signaling could be used to tell a decoder or attached renderer to use a well-defined/standardized form of temporal interpolation. However, doing so requires the standardization of both a temporal interpolation technology and the signaling support for it, neither of which is available today in TV, video-conferencing, or video-telephony protocols.

ITU-T Rec. H.264 Annex G, alternatively known as Scalable Video Coding or SVC, henceforth denoted as “SVC”, and available from http://www.itu.int/rec/T-REC-H.264-200903-1 or the International Telecommunication Union, Place des Nations, 1211 Geneva 20, Switzerland, includes the “slice_skip_flag” syntax element, which enables a mode that we will refer to as “Slice Skip mode”. Skipped slices according this mode, and as used in this invention, were introduced in document JVT-S068 (available from http://wftp3.itu.int/av-areh/jvt-site/2006_{—}04_Geneva/JVT-S068.zip) as a simplification and straightforward enhancement of the SVC syntax. However, neither this document, nor the meeting report of the relevant JVT meeting (http://wftp3.itu.int/av-arch/jvt-site/2006_{—}04_Geneva/AgendaWithNotes_d8.doc) provide any information for use of the syntax element proposed and adopted that would be similar to the invention presented.

### SUMMARY OF THE INVENTION

Disclosed herein are techniques and computer readable media containing instructions arranged to utilize existing video compression techniques to enhance a visually appealing high frame rate, without incurring the bitrate and computational complexity common to high frame rate coding using conventional techniques. SVC skip slices—that is slices in which the slice_skip_flag in the slice header is set to a value of 1—require very few bits in the bitstream, thereby keeping the bitrate overhead very low. Also, when using an appropriate implementation, the computational requirements for coding an enhancement layer picture consisting entirely of skipped slices are almost negligible. However, the decoder operation upon the reception of a skip slice is well defined. Further, skipped slices in an enhancement layer inherit motion information from the base layer(s), thereby minimizing, if not eliminating, the possibly bad correlation between nonlinear motion and linear interpolation. Also, the aforementioned issue of radical brightness changes of a picture (or significant part thereof) does not exist, as the base layer is coded at full frame rate and may contain information related to the brightness change that may also be inherited by the enhancement layer.

According to one exemplary embodiment of the invention, a layered encoder utilizes at least one basing layer at a higher frame rate to represent an input signal. A “basing layer” consists either of a single base layer, or a single base layer and one or more enhancement layers. It further utilizes at least one spatial enhancement layer at a lower frame rate with a spatial resolution higher than the basing layer(s), and at least one temporal enhancement layer with a higher frame rate enhancing the spatial enhancement layer. Within this temporal enhancement layer, at least one picture is coded at least in part as one or more skip slices.

As an example, the basing layer consists only of a base layer. The base layer is coded at 60 Hz. The spatial enhancement layer is coded at 30 Hz. The temporal enhancement layer is coded at 60 Hz, using skip slices only, and the resulting coded pictures will be referred to as “skip pictures.”

In the example, at the decoder, after transmission, the base layer, spatial enhancement layer and temporal enhancement layer are decoded together (it is irrelevant for the invention which precise technique of decoding is employed—both single loop decoding and multi-loop decoding will produce the same results). As the enhancement layer's motion vectors, coarse texture information, and other information are inherited from the base layer(s), the amount of interpolation spatio/temporal artifacts is reduced. This results, after decoding, in a reproducible, visually pleasing, high quality signal at the high frame rate of 60 Hz.

Nevertheless, the encoding complexity and the bitrate demands are reduced. The computational demands for coding the temporal enhancement layer are reduced to virtually zero. The bitrate is also reduced significantly, although quantizing this amount is difficult as it highly depends on the signal.

Several other modes of operation are also possible.

In the same or another embodiment, the layering structure may be more complex, e.g., more than one temporal enhancement layer can be used that include skip slices. For example, an encoder can be devised that implements the spatial enhancement layer at 30 Hz, and two temporal enhancement layers at 60 Hz and 120 Hz. Using techniques such as those disclosed in U.S. Pat. No. 7,593,032 and co-pending U.S. patent application Ser. No. 12/539,501, a receiver can receive and decode only those temporal enhancement layers it is capable of decoding and displaying; other enhancement layers produced by the encoder are discarded by the video router.

In the same or another embodiment, SNR scalability can be used. An “SNR scalable layer” is a layer that enhances the quality (typically measurable in Signal To Noise ratio, “SNR”) without increasing frame rate or spatial resolution, by providing for, among other things, finer quantized coefficient data and hence less quantization error in the texture information. Conceivably, the temporal enhancement layer(s) can be based on the SNR scalable layer instead of or in addition to, a spatial enhancement layer as described above.

In the same or another embodiment, skip slices can cover parts of the temporal enhancement layer. For example, a sufficiently powerful encoder can code the background information (e.g., walls, etc.) of the temporal enhancement layer by using skip slices, whereas it codes the foreground information (i.e., face of the speaker) regularly using the tools commonly known for temporal enhancement layers.

### BRIEF DESCRIPTION OF THE DRAWINGS

FIG. 1 is a block diagram illustrating an exemplary architecture of a video transmission system in accordance with the present invention.

FIG. 2 is an exemplary layer structure of an exemplary layered bitstream in accordance with the present invention.

### DETAILED DESCRIPTION OF THE INVENTION

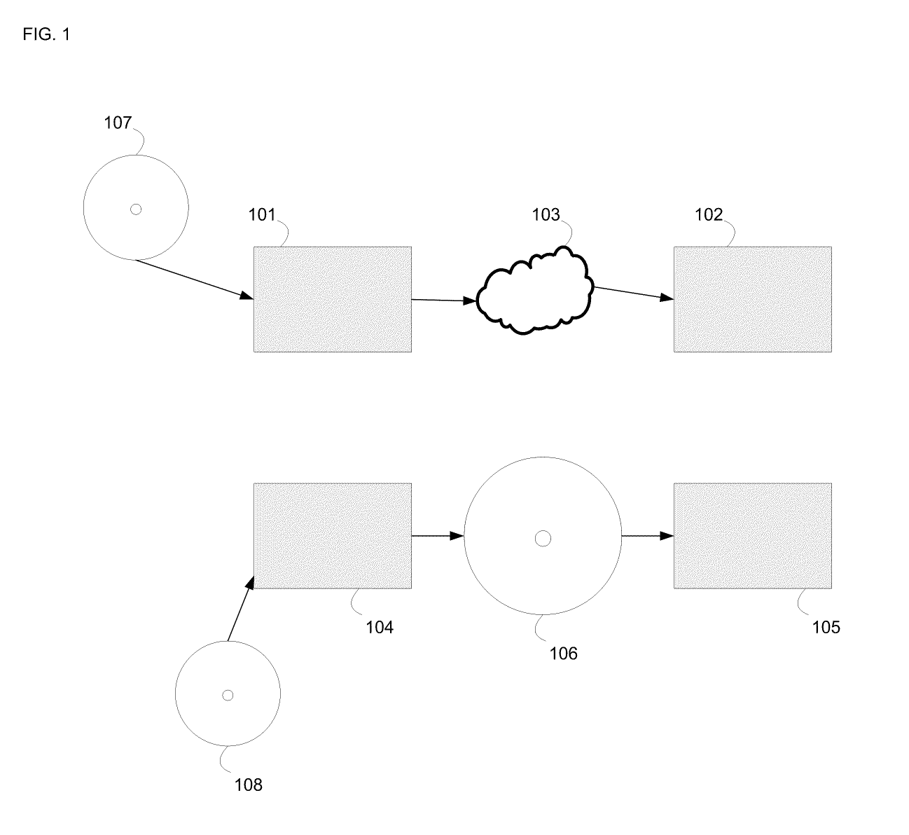

FIG. 1 depicts an exemplary digital video transmission system that includes an encoder (101), at least one decoder (102) (not necessarily in the same location, owned by the same entity, operating at the same time, etc.), and a mechanism to transmit the digital coded video data, e.g., a network cloud (103). Similarly, an exemplary digital video storage system also includes an encoder (104), at least one decoder (105) (not necessarily in the same location, owned by the same entity, operating at the same time, etc.), and a storage medium (106) (e.g., a DVD). This invention concerns the technology operating in the encoder (101 and 104) of a digital video transmission, digital video storage, or similar setup. The other elements (102, 103, 105, 106) operate as usual and do not require any modification to be compatible with the encoders (101, 104) operating according to the invention.

An exemplary digital video encoder (henceforth “encoder”) applies a compression mechanism to the uncompressed input video stream. The uncompressed input video stream can consist of digitized pixels at a certain spatiotemporal resolution. While the invention can be practiced with both variable resolutions and variable input frame rates, for the sake of clarity, henceforth a fixed spatial resolution and a fixed frame rate is assumed and discussed. The output of an encoder is typically denoted as a bitstream, regardless whether that bitstream is put as a whole or in fragmented form into a surrounding higher-level format, such as a file format or a packet format, for storage or transmission.

The practical implementation of an encoder depends on many factors, such as cost, application type, market volume, power budget, form factor, and others. Known encoder implementations include full or partial silicon implementations (which can be broken into several modules), implementations running on DSPs, implementations running on general purpose processors, or a combination of any of these. Whenever a programmable device is involved, part or all of the encoder can be implemented in software. The software can be distributed on a computer readable media (107, 108). The present invention does not require or preclude any of the aforementioned implementation technologies.

While not restricted exclusively to layered encoders, this invention is utilized more advantageously in the context of a layered encoder. The term “layered encoder” refers herein to an encoder that can produce a bitstream constructed of more than one layer. Layers in a layered bitstream stand in a given relationship, often depicted in the form of a directed graph.

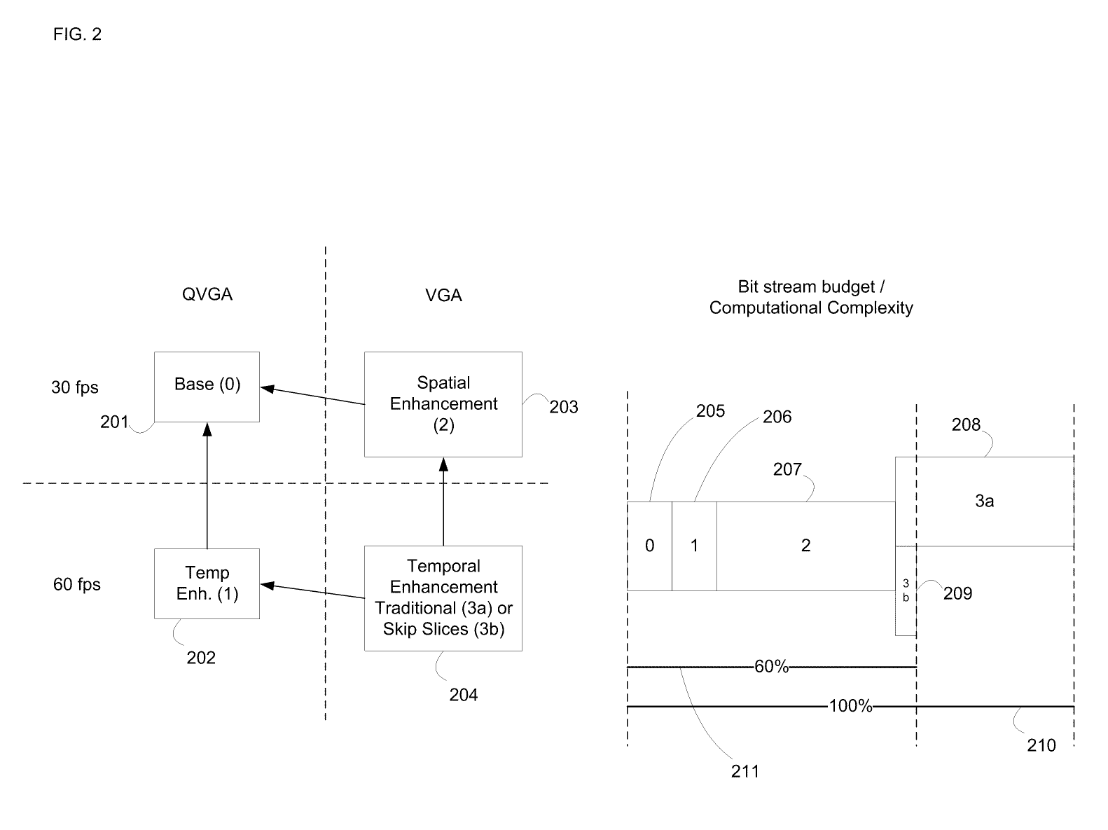

FIG. 2 depicts an exemplary layer structure of a layered bitstream in accordance with the present invention. A base layer (201) can be coded at QVGA spatial resolution (320×240 pixels) and at a fixed frame rate of 30 Hz. A temporal enhancement layer (202) enhances the frame rate to 60, but still at QVGA resolution. A spatial enhancement layer (203) enhances the base layer's resolution to VGA resolution (640×480 pixels), at 30 Hz. Another temporal enhancement layer (204) enhances the spatial enhancement layer (203) to 60 Hz at VGA resolution.

Arrows denote the dependencies of the various layers. The base layer (201) does not depend on any other layer and can, therefore, be meaningfully decoded and displayed by itself. The temporal enhancement layer (202) depends on the base layer (201) only. Similarly, the spatial enhancement layer (203) depends on the base layer only. The temporal enhancement layer (204) depends directly on the two enhancement layers (202) and (203), and indirectly on the base layer (201).

Modern video communication systems, such as those disclosed in U.S. Pat. No. 7,593,032 and co-pending U.S. patent application Ser. No. 12/539,501 can take advantage of layering structures such as those depicted in FIG. 2 in order to transmit, relay, or route only those layers to a destination to process.

Prior art layered encoders often employ similar, if not identical, techniques to code each layer. These techniques can include what is normally summarized as inter-picture prediction with motion compensation, and can require motion vector search, DCT or similar transforms, and other computationally complex operations. While a well-designed layered encoder can utilize synergies when coding different layers, the computational complexity of a layered encoder is still often considerably higher than that of a traditional, non-layered encoder that uses a similar complex coding algorithm and a resolution and frame rate similar to the layered encoder at the highest layer in the layering hierarchy.

As its output after the coding process, a layered encoder produces a layered bitstream. In one exemplary embodiment, the layered bitstream includes, in addition to header data, bits belonging to the four layers (201, 202, 203, 204). The precise structure of the layered bitstream is not relevant to the present invention.

Still referring to FIG. 2, if a regular coding algorithm were applied to all four layers (201, 202, 203, 204), a bit stream budget can be such that, for example, the base layer (201) uses 1/10th of the bits (205), the temporal enhancement layer (202) also uses 1/10th of the bits (206), and the enhancement layers (203) and (204) each use 4/10th of the bits (207, 208). This can be justified by using the same number of bits per pixel per time interval. Other titrate allocations can be used that can result in more pleasing visual performance. For example, a well-built layered encoder can allocate more bits to those layers that are used as base layers than to enhancement layers, especially if the enhancement layer is a temporal enhancement layer.

A reduction of the bitrate is desirable. If all pictures of the temporal enhancement layer (204) were coded in the form of one large skip slice, covering the spatial area of the whole picture, the bitrate (209) of the enhancement layer would decrease to, e.g., a few hundred bits per second, from, e.g., more than a megabit per second. As a result, by using the invention as discussed, the bitrate of the layered bitstream, set as 100% without use of the invention (210), would be around 60% with the invention in use (211).

Very similar considerations apply to computational complexity. The allocation of computational complexity is often described in “cycles”. A cycle can be, for example, an instruction of a CPU or DSP, or another form of measuring a fixed number of operations. If a regular coding algorithm were applied to all four layers, it can be such that the base layer (201) uses 1/10th of the cycles (205), the temporal enhancement layer (202) also 1/10th of the cycles (206), and the enhancement layers (203) and (204) each 4/10th of the cycles (207, 208). This can be justified by using the same number of bits per pixel per time interval. It should be noted that other cycle allocations can be used that can result in a more optimized overall cycle budget. Specifically, the above-mentioned cycle allocation does not take into account synergy effects between the coding of the various layers. In practice, a well-built layered encoder can allocate more cycles to those layers that are used as base layers than to enhancement layers, especially if the enhancement layer is a temporal enhancement layer.

A reduction of the total cycle count, and therefore overall computational complexity, is desirable. If, for example, all pictures of the enhancement layer (204) were coded in the form of one large skip slice, covering the spatial area of the whole picture, the cycle count for the coding of the enhancement layer would go down to very low number, e.g., many orders of magnitude lower than coding the layer in its traditional way. That is because none of the truly computationally complex operations such as motion vector search or transform would ever be executed. Only the few bits representing a skip slice need to be placed in the bitstream, which can be a very computationally non-complex operation. As a result, by using the invention as discussed, the cycle count of the layered bitstream, set as 100% without use of the invention (210), would be around 60% with the invention in use (211).

The syntax for coding a skip slice is described in ITU-T Recommendation H.264 Annex G version March/2009, section 7.3.2.13, “skip_slice_flag”, and the semantics of that flag can be found on page 428ff in the semantics section, available from http://www.itu.int/rec/T-REC-H.264-200903-I or the International Telecommunication Union, Place des Nations, 1211 Geneva 20, Switzerland. The bits to be included in the bitstream representing a skip slice are obvious to a person skilled in the art after having studied the ITU-T Recommendation H.264.

1. A method for encoding a video sequence into a bitsteam, the method comprising:
(a) Coding a basing layer at a first frame rate that is a fraction of the frame rate of the video sequence,
(b) Coding a first spatial enhancement layer based on the basing layer at the first frame rate,
(c) Coding a second temporal enhancement layer at a second frame rate, based on the basing layer, where the second frame rate is higher than the first frame rate but lower than or equal to the frame rate of the video sequence, and
(d) Coding a third enhancement layer at a third frame rate, based on the basing layer, the first spatial enhancement layer and the second temporal enhancement layer,
wherein the third enhancement layer's coded pictures consists entirely of skipped macroblocks.

2. The method of claim 1, wherein the skipped macroblocks are represented by at least one slice with the slice_skip_flag set.

3. The method of claim 1, wherein the frame rates are variable.

4. The method of claim 1, wherein the frame rates are fixed.
